(19) United States
(12) Patent Application Publication
(10) Pub. No.: US 2026/0285424 A1
(43) Pub. Date: Sep. 24, 2026

(54) DRIVETRAIN CONFIGURATION FOR WORK VEHICLE

(71) Applicant: Deere & Company, Moline, IL (US)

(72) Inventor: Steven R. Whiteman, Dubuque, IA (US)

(21) Appl. No.: 19/087,547

(22) Filed: Mar. 23, 2025

(51) Int. Cl. B62D 55/04; B60K 17/342; B60K 17/356; B62D 55/125; B62D 55/14

(52) U.S. Cl. CPC B62D 55/04; B60K 17/342; B60K 17/356; B62D 55/125; B62D 55/14

(57) ABSTRACT

A drivetrain for a work vehicle for switching between a tracked configuration and a wheeled configuration is disclosed. The drivetrain comprises a final drive, a drive sprocket, a driven sprocket, a chain, and a dual-mode axle. The drive sprocket is coupled to the final drive and rotatable around a drive sprocket axis by an output of the final drive. The chain connects the drive sprocket and the driven sprocket. The chain is configured to rotate the driven sprocket around a driven sprocket axis. The dual-mode axle is coupled to and rotatable by the driven sprocket. The dual-mode axle is configured to rotate a track sprocket of a track assembly to drive a track when disposed in the tracked configuration. The dual-mode axle is also configured to rotate a wheel of a wheel assembly when disposed in the wheeled configuration.

### TECHNICAL FIELD

The present disclosure relates generally to a work vehicle including but not limited to skid steer loaders.

### BACKGROUND

Currently, work vehicles, such as skid steer loaders, may be categorized as either tracked work vehicles or wheeled work vehicles, not both. The main frame of each work vehicle may be designed exclusively for the track vehicles or wheel work vehicles after track assemblies or wheel assemblies are assembled thereto in the factory.

### SUMMARY

According to an aspect of the present disclosure, a work vehicle switchable between a tracked configuration and a wheeled configuration is disclosed. The work vehicle comprises a main frame, a power source, a first ground engaging device, and a first common drive assembly. The main frame extends along a central longitudinal axis between a front end and a rear end relative to a direction of travel. The first ground engaging device includes one of a first track assembly or a first wheel assembly and is configured to move the work vehicle in the direction of travel. The first common drive assembly is coupled to the main frame and connected to the power source for receiving torque therefrom. The first common drive assembly includes a first motor, a first final drive, a first drive sprocket, a first driven sprocket, a first chain, and a dual-mode axle. The first final drive is coupled to the first motor. The first motor is configured to drive the first final drive. The first drive sprocket is coupled to the first final drive and rotatable around a first drive sprocket axis by an output of the first final drive. The first chain connects the first drive sprocket and the first driven sprocket. The first chain is configured to rotate the first driven sprocket around a first driven sprocket axis. The dual-mode axle is coupled to and rotatable by the first driven sprocket. The dual-mode axle is configured to rotate a track sprocket of the first track assembly to drive a track when disposed in the tracked configuration. The dual-mode axle is also configured to rotate a wheel of the first wheel assembly when disposed in the wheeled configuration.

According to an aspect of the present disclosure, a drivetrain for a work vehicle for switching between a tracked configuration and a wheeled configuration is disclosed. The drivetrain comprises a final drive, a drive sprocket, a driven sprocket, a chain, and a dual-mode axle. The drive sprocket is coupled to the final drive and rotatable around a drive sprocket axis by an output of the final drive. The chain connects the drive sprocket and the driven sprocket. The chain is configured to rotate the driven sprocket around a driven sprocket axis. The dual-mode axle is coupled to and rotatable by the driven sprocket. The dual-mode axle is configured to rotate a track sprocket of a track assembly to drive a track when disposed in the tracked configuration. The dual-mode axle is also configured to rotate a wheel of a wheel assembly when disposed in the wheeled configuration.

Because of the disclosed configuration, the operator or the service provider can easily switch the tracked assembly and wheel assembly as needed.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1A is a simplified top view of a work vehicle in a tracked configuration.

FIG. 1B is a simplified left side view of the work vehicle of FIG. 1A.

FIG. 1C is an exploded view of an idler wheel and a first common drive assembly of the work vehicle.

FIG. 2A is a simplified top view of the work vehicle in a wheeled configuration.

FIG. 2B is a simplified left side view of the work vehicle of FIG. 2A.

FIG. 2C is a perspective cross-sectional view of a final drive, a front wheel coupler, and shaft components.

FIG. 2D is a partial enlarged cross-sectional view of elements illustrated in FIG. 2C.

Like reference numerals are used to indicate like elements throughout the several figures.

### DETAILED DESCRIPTION

The present disclosure includes one or more of the implementations of a work vehicle, which has commonality thereof, switchable between a tracked configuration and wheel configuration, depending on the operator's need. The work vehicle, in one example, may be a skid steer loader. Motor(s), including but not limited to, hydrostatic motors and electric motors, may be used to drive track assembly(ies) and wheel assembly(ies), depending on the tracked configuration or the wheeled configuration. The motors may be driven by one of various power sources, such as a combustion engine (e.g., diesel engine) or battery assembly. In one implementation, the combustion engine may drive a hydraulic pump to further drive the hydrostatic motors. In another implementation, the battery assembly may drive a hydraulic pump to further drive the hydrostatic motors. In another embodiment, the battery assembly may drive electric components to power the electric motors.

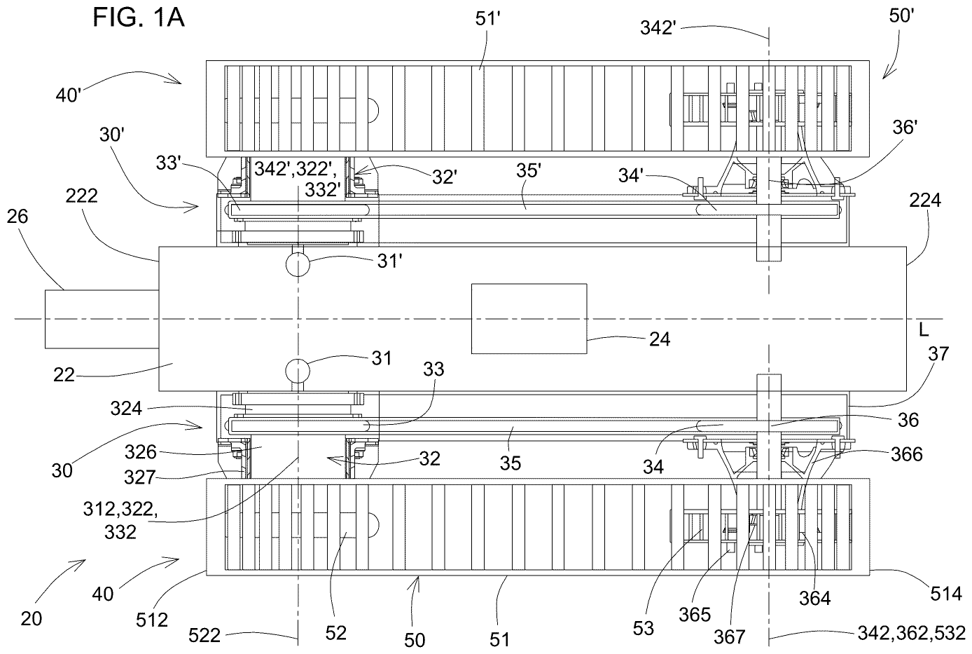

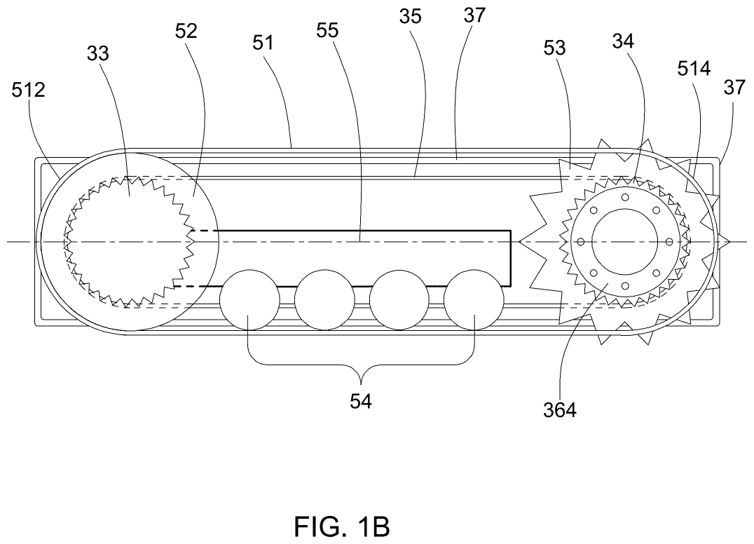

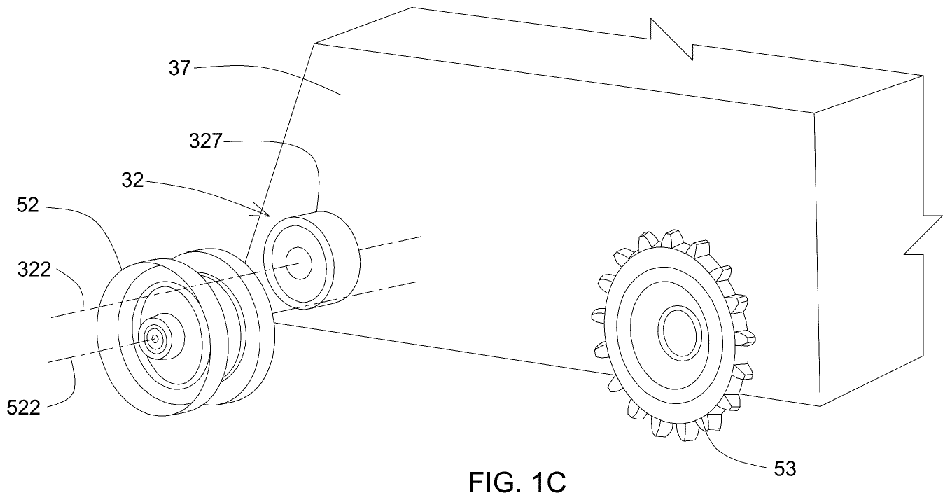

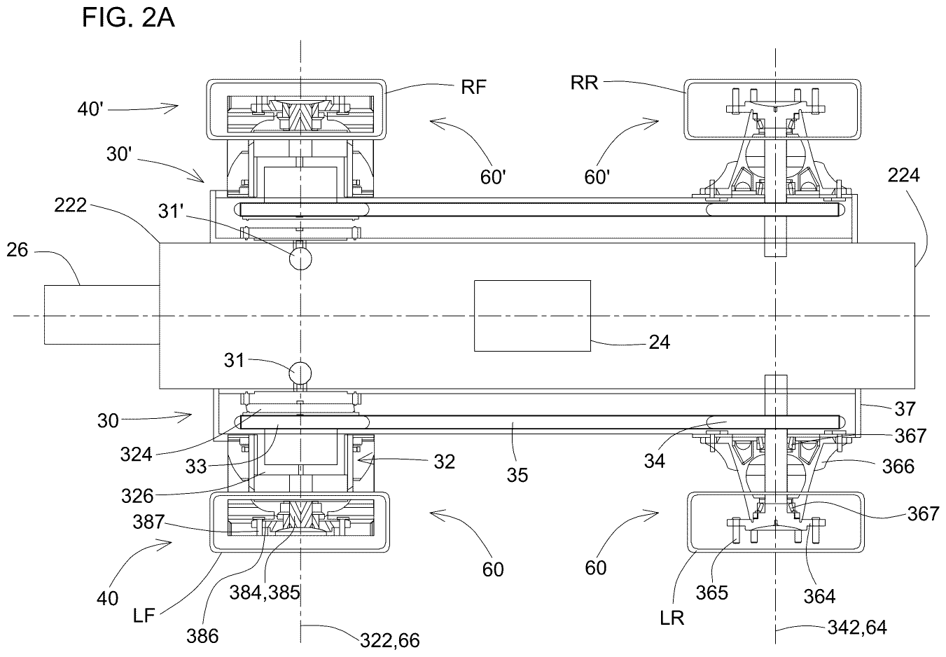

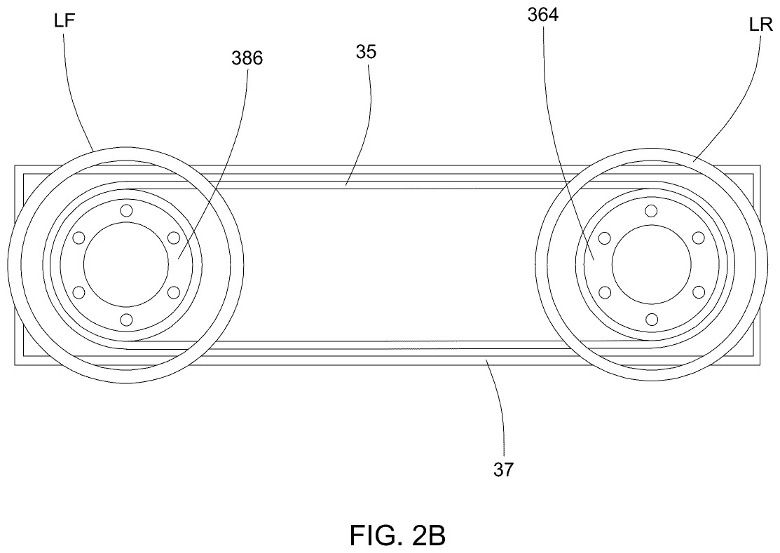

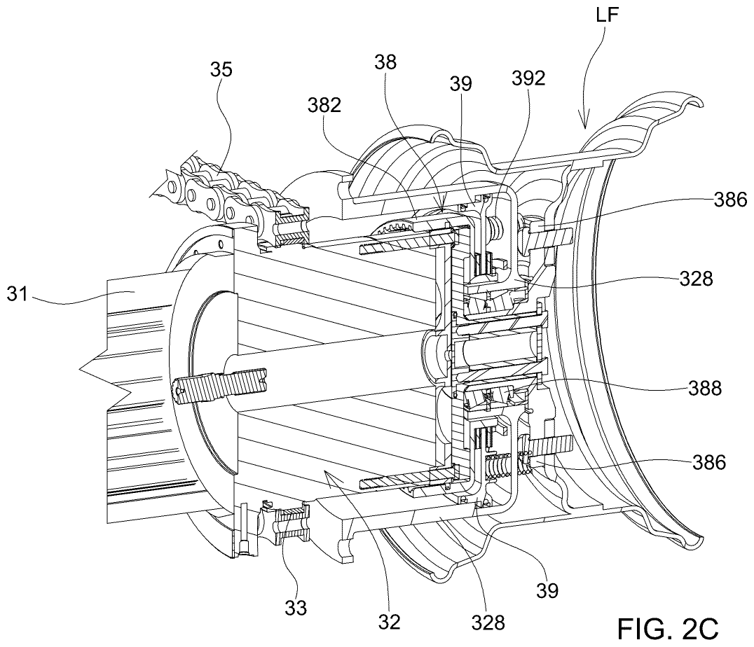

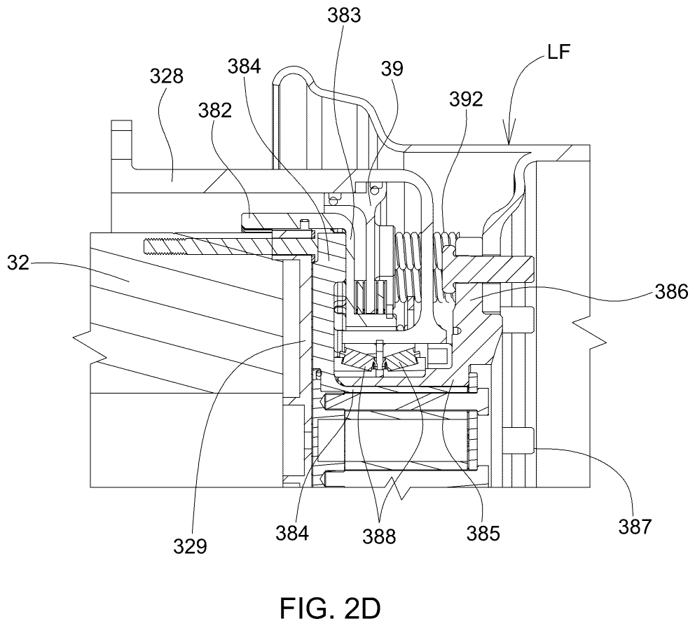

A work vehicle 20 in a tracked configuration is illustrated in FIGS. 1A-1C; the work vehicle 20 in a wheeled configuration is illustrated in FIGS. 2A, 2B. The work vehicle 20, disposed in the tracked configuration and wheeled configuration, may have a main frame 22, a power source 24, an implement 26, a first common drive assembly 30, and a second common drive assembly 30′. The main frame 20 may carry a cab (not shown) and extend along a central longitudinal axis L between a front end 222 and a rear end 224 relative to a direction of travel. The power source 24, as described above, may be used to drive a first motor 31 and a second motor 31′ to move the work vehicle 20. The implement 26 in this disclosure may include a boom, an arm, and a bucket and can be moved relative to the main frame 22 to perform tasks. The first common drive assembly 30 in FIGS. 1A-2B is a left common drive assembly coupled to the left side of the main frame 22. The second common drive assembly 30′ is a right common drive assembly which is coupled to the right side of the main frame 22.

The first common drive assembly 30 is coupled to the main frame 22 and connected to the power source 24 for receiving torque therefrom. The first common drive assembly 30 includes the first motor 31, a first final drive 32, a first drive sprocket 33, a first driven sprocket 34, a first chain 35, and a dual-mode axle 36. The first motor 31 is rotatable around an axis 312. In one implementation, the first motor 31 is an electric motor. The first final drive 32 is coupled to the first motor 31. The first motor 31 is configured to drive the first final drive 32 around an axis 322. The first final drive 32 may include a speed reduction apparatus, such as a planetary gearset. It is noted that in one implementation, the first motor 31 is operably disposed in a front portion of the main frame 22. This arrangement allows a rear portion of the main frame 22 to have space to support various components, such as engine, hydraulic fluid pump, and/or battery assembly. The dual-mode axle 36 is a rear axle.

The first common drive assembly 30 may further include a chain case 37, which stores fluid therein. The fluid, for example, is oil. The first drive sprocket 33, the first driven sprocket 34, and the first chain 35 are enclosed in the chain case 37 and at least partially submerged in the oil for lubrication and cooling. A motor shaft of the first motor 31 extends from the first motor 31, through an opening of the chain case 37, to the first final drive 32. A seal (not shown) and may be positioned around the opening of the chain case 37. The first final drive 32 may be partially disposed in the chain case 37. As shown in FIG. 1A, the first final drive 32 may include an inner portion 324 disposed inside the chain case 37 and an outer portion 326 disposed outside of the chain case 37. A seal (not shown) may be positioned around an opening of the chain case 37 which the first final drive 32 passes through to prevent oil leak.

The first drive sprocket 33 is coupled to the inner portion 324 of the first final drive 32. The first motor 31 and the first final drive 32 may be operable to selectively rotate the first drive sprocket 33. The first drive sprocket 33 in this example may surround the inner portion 324 of the first final drive 32 and engage gear(s) of the first final drive 32 to receive the torque or an output therefrom. The first drive sprocket 33 is rotatable around a first drive sprocket axis 332 by the output of the first final drive 32. In one example, at least two of the axes 312, 322, and the first drive sprocket axis 332 are coaxial. The first chain 35 connects the first drive sprocket 33 and the first driven sprocket 34. The first drive sprocket 33 and the first driven sprocket 34 have multiple teeth to engage the first chain 35. The first chain 35 is configured to rotate the first driven sprocket 34 around a first driven sprocket axis 342. The first chain 35 transmits mechanical power from the first drive sprocket 33 to the first driven sprocket 34. The dual-mode axle 36 is coupled to and rotatable by the first driven sprocket 34. The dual-mode axle 36 may provide torque to a first ground engaging device 40, which is described later.

The work vehicle 20 may include the first ground engaging device 40 and a second ground engaging device 40′. The first ground engaging device 40 is coupled to the first common drive assembly 30; the second ground engaging device 40′ is coupled to the second common drive assembly 30′. The second common drive assembly 30′ is a mirror structure of the first common drive assembly 30. The second ground engaging device 40′ is a mirror structure of the first ground engaging device 40. Therefore, for concise purposes, the first common drive assembly 30 and the first ground engaging device 40 are described in detail and the second common drive assembly 30′ and the second ground engaging device 40′ are described in brevity.

The first ground engaging device 40 includes one of a first track assembly 50 when the work vehicle 20 is disposed in a tracked configuration or a first wheel assembly 60 when the work vehicle 20 is disposed in a wheeled configuration. The second ground engaging device 40′ includes one of a second track assembly 50′ when the work vehicle 20 is disposed in the tracked configuration or a second wheel assembly 60′ when the work vehicle 20 is disposed in the wheeled configuration. The first ground engaging device 40 and the second ground engaging device 40′ are configured to move the work vehicle 20 in the direction of travel.

Referring to FIGS. 1A-1C, the first track assembly 50 includes a track 51, an idler roller 52, a track sprocket 53, and a plurality of track rollers 54. The idler roller 52 is rotatable around an idler roller axis 522. The track sprocket 53 is rotatable around a track sprocket axis 532. The track 51 extends around the idler roller 52, the track sprocket 53, and the track rollers 54. The idler roller 52 is disposed at a front inner end 512 of the track 51 and the track sprocket 53 is disposed at a rear inner end 514 of the track 51. In one example, a diameter of the idler roller 52 and a diameter of the track sprocket 53 are substantially identical, and the idler roller 52 and the track sprocket 53 are spaced apart relative to the direction of travel to tension the track 51 in an oval shape. The oval track may have low undercarriage drag, good track life, and low weight. In another example, the track 51 can be different shape. The plurality of track rollers 54 are aligned with the direction of travel and engages a lower portion of track 51. The track rollers 54 facilitate the lower portion of the track 51 to engage the ground. The idler roller 52 and the track rollers 54 may be rotatably mounted to a track frame 55. The track frame 55 is coupled to the chain case 37 and streamlines the installation of the idler roller 52 and track rollers 54. In one implementation, the track frame 55 is bolted to the chain case 37. The chain case 37 is integral to the main frame 22.

When the work vehicle 20 is disposed in the track configuration, a power flow from the first final drive 32 is transferred through the first drive sprocket 33, the first chain 35, the first driven sprocket 34 to the dual-mode axle 36. The dual-mode axle 36 then rotates the track sprocket 53 of the first track assembly 50 to drive the track 51. The track 51 circulates about its path around the idler roller 52 and the track rollers 54. The dual-mode axle 36 may be surrounded and supported by a housing 366 which is coupled to the chain case 37. The housing 366 is bolted to the chain case 37, for example. At least two bearings 367 are disposed radially between the housing 366 and the dual-mode axle 36. An outer end of the dual-mode axle 36 may include a flange 364, which extends radially relative to the dual-mode axle 36. The track sprocket 53 is attached to the flange 364. In one example, the track sprocket 53 is attached to the flange 364 via fasteners like bolts 365. The dual-mode axle 36 defines a first axis 362 of rotation, and the track sprocket 53 defines a track sprocket axis 532 for rotating therearound. The track sprocket axis 532 is aligned co-axial with the first axis 362 of rotation. Because the power flow from the first final drive 32 is not conveyed to the idler roller 52 and there is no rotating shaft or axle connecting the idler roller 52 to the outer portion 326 of the first final drive 32, the distance between the idler roller 52 and the track sprocket 53 can be decided based on the needs. The idler roller axis 522 and the first drive sprocket axis 332 can be offset, as shown in FIG. 1C. The first final drive 32 may have a final drive housing 327 bolted to the chain case 37 and covering the gear set, bearings and other components. The final drive 327 is connected to the chain case 37. A sealing (not shown) is disposed between the final drive housing 327 and the chain case 37 to prevent oil leak.

It is noted that when the work vehicle 20 is switched from the tracked configuration to the wheeled configuration, the final drive housing 327 is unbolted from the chain case 37 and replaced with another final drive housing 328 (shown in FIGS. 2C, 2D), which is disclosed later. The track sprocket 53 is unbolted from the flange 364 and replaced with the left rear wheel LR (shown in FIGS. 2A, 2B).

Referring to FIG. 1A, the second common drive assembly 30′ is coupled to the main frame 22 and connected to the power source 24 for receiving torque therefrom. The second common drive assembly 30′ includes the second motor 31′, a second final drive 32′, a second drive sprocket 33′, a second driven sprocket 34′, a second chain 35′, and a second dual-mode axle 36′. The second motor 31′ is rotatable around an axis 312′. The second final drive 32′ is coupled to the second motor 31′. The second motor 31′ is configured to drive the second final drive 32′ around an axis 322′. The second drive motor 31′ and the second final drive 32′ may be operable to selectively rotate the second drive sprocket 33′. The second drive sprocket 33′ is rotatable around a second drive sprocket axis 332′ by the output of the second final drive 32′. In one example, at least two of the axes 312′, 322′, and the second drive sprocket axis 332′ are coaxial. The second chain 35′ connects the second drive sprocket 33′ and the second driven sprocket 34′. The second chain 35′ is configured to rotate the second driven sprocket 34 around a second driven sprocket axis 342′. The second chain 35′ transmits mechanical power from the second drive sprocket 33′ to the second driven sprocket 34′. The second dual-mode axle 36′ is coupled to and rotatable by the second driven sprocket 342′. The second dual-mode axle 36′ may provide torque to the second ground engaging device 40′. The second dual-mode axle 36′ is configured to rotate the second track sprocket of the second track assembly 50′ to drive a track 51′ when disposed in the tracked configuration.

Referring to FIGS. 2A, 2B, the work vehicle 20 is disposed in the wheeled configuration. The first wheel assembly 60 of the first ground engaging device 40 is coupled to the first common drive assembly 30, and the second wheel assembly 60′ of the second ground engaging device 40′ is coupled to the second common drive assembly 30′. Here, the first common drive assembly 30 and the second common drive assembly 30′ are the same as described in tracked configuration. The first wheel assembly 60 may include a left front wheel LF, a front wheel coupler 38, and a left rear wheel LR. The second wheel assembly 60′ may include a right front wheel RF and a right rear wheel RR. Because the second wheel assembly 60′ is the mirror structure of the first wheel assembly 60, the description focuses on the first wheel assembly 60 for brevity. The left rear wheel LR is attached to the flange 364, which is used for attachment of the track sprocket 53 when the work vehicle 20 is disposed in the tracked configuration. In one example, left rear wheel LR is attached to the flange 364 via fasteners like bolts 365 (may be the same bolts used to connect the track sprocket 53 or different bolts). The dual-mode axle 36 for the wheeled configuration is to rotate the left rear wheel LR of the first wheel assembly 60 around an axis 64. The left rear wheel LR defines the axis 64 for rotating therearound. The axis 64 is coaxial with the first axis 362 of rotation. The right rear wheel RR is attached to the second dual-mode axle 36′ in a similar fashion.

Referring to FIGS. 2C, 2D, the chain case 37 and the tire of the left front wheel LF are omitted in the illustration. The front wheel coupler 38 connects the left front wheel LF and the first final drive 32. The front wheel coupler 38 may include a spline portion 382 extending axially and a wall 383 connected to the spline portion 382 and extending radially. A distal end of the first final drive 32 may include a gear 329. The gear 329 of the first final drive 32 and the spline portion 382 of the front wheel coupler 38 may be meshed for transmitting a portion of the power flow. A first shaft component 384 may include a radially extended wall, which is disposed between the gear 329 and wall 383 and configured to receive the portion of the power flow from the front wheel coupler 38. The first shaft component 384 may also include an axially extended sleeve with teeth on its outer diameter. A second shaft component 385 may include an axially extended sleeve with teeth on its inner diameter. The axially extended sleeve of the second shaft component 385 surrounds and interlocks the axially extended sleeve of the second shaft component 384 to receive the portion of the power flow from the first shaft component 38. The outer end of the second shaft component 384 may extend radially to form a flange 386. In one example, the left front wheel LF is attached to the flange 386 via fasteners like bolts 387. The front wheel coupler 38, the first shaft component 384, the second shaft component 385, and the left front wheel LF are rotatable around axis 66. The first final drive 32 may rotate coaxially with the left front wheel LF. At least two bearings 388 is disposed radially between the final drive housing 328 and the second shaft component 385. A clutch may be used to determine whether a portion of the power flow from the first final drive 32 is transferred to the left front wheel LF. As shown in FIGS. 2C, 2D, a piston 39 is operable to engage the front wheel coupler 38. A plurality of clutch springs 392 interconnect the flange 386 and the back of the piston 39. The clutch, having the piston 39, may be a spring applied, hydraulic release (SAHR) dog clutch. In one implementation, when the clutch is engaged (the piston 39 is engaged with the axially extended wall of the first shaft component 384), the power flow from the first final drive 32 is split between the shaft component 385 and the dual-mode axle 36 (rear axle). A portion of the power flow is transferred through the first drive sprocket 33, the first chain 35, the first driven sprocket 34 to the dual-mode axle 36 to rotate the left rear wheel LR. The other portion of the power flow is transferred through the front wheel coupler 38, the first shat component 384, and the second shaft component 385 to rotate the left front wheel LF. In another implementation, when the clutch is disengaged, the power flow from the first final drive 32 is transferred, without a split, through the first drive sprocket 33, the first chain 35, the first driven sprocket 34 to the dual-mode axle 36 to rotate the left rear wheel LR. Likewise, a power flow from the second final drive 32′ may split between the right front wheel RF and the right rear wheel RR or substantially transferred to the right rear wheel RR without a split.

The final drive housing 328, the front wheel coupler 38, the first shaft component 384, the second shaft component 385, and the piston 39 may be coupled together as a single unit, which is convenient for the operator to take off the final drive housing 328 to disconnect the front wheel coupler 38 and the first final drive 32. It is noted that when the work vehicle 20 is switched from the wheeled configuration to the tracked configuration, the final drive housing 328 is unbolted from the chain case 37 and replaced with final drive housing 327 (shown in FIG. 1C). The front wheel coupler 38, the first shaft component 384, the second shaft component 385, and the piston 39 are disconnected from the first final drive 32 with the replacement. The left rear wheel LR is unbolted from the flange 364 and replaced with track sprocket 53 (shown in FIGS. 1A, 1B).

Without in any way limiting the scope, interpretation, or application of the claims appearing below, a technical effect of one or more of the example embodiments disclosed herein is to provide common drive assemblies that allow the work vehicle to switch between the tracked configuration and wheeled configuration easily. The operator or the service provider can easily switch the tracked assembly and wheel assembly as needed. For an unlimiting example, when the operator changes the work vehicle from the tracked configuration to wheeled configuration, the operator can (1) remove the track sprocket, such as unbolting bolts from the dual-mode axle; (2) take off the idler wheel and the track rollers, which may be coupled with the track frame that connects the main frame or the common drive assembly; (3) remove the track; (4) take off the first final drive housing; and (5) attach the rear wheel on the dual-mode axle and connect the front wheel to the final drive with another final drive housing having the front wheel coupler. When the operator changes the work vehicle from the wheeled configuration to tracked configuration, the operator can (1) take off the rear wheel on the dual-mode axle and disconnect the front wheel from the final drive with the final drive housing having the front wheel coupler removed from the final drive; (2) attach a final drive housing, which does not have the front wheel coupler; (3) attach the track sprocket to the dual-mode axle; (4) connect the track frame having the idler wheel and the track roller to the chain case; and (5) apply the track to extend around the idler wheel, the track rollers, and the track sprocket. The aforementioned order of step may be interchangeable as needed.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally,” “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A work vehicle switchable between a tracked configuration and a wheeled configuration, the work vehicle comprising:
a main frame extending along a central longitudinal axis between a front end and a rear end relative to a direction of travel;
a power source;
a first ground engaging device including one of a first track assembly or a first wheel assembly and configured to move the work vehicle in the direction of travel;
a first common drive assembly coupled to the main frame and connected to the power source for receiving torque therefrom, the first common drive assembly including:
a first motor;
a first final drive coupled to the first motor, wherein the first motor is configured to drive the first final drive;
a first drive sprocket coupled to the first final drive and rotatable around a first drive sprocket axis by an output of the first final drive;
a first driven sprocket;
a first chain connecting the first drive sprocket and the first driven sprocket, wherein the first chain is configured to rotate the first driven sprocket around a first driven sprocket axis; and
a dual-mode axle coupled to and rotatable by the first driven sprocket, wherein the dual-mode axle is configured to rotate a track sprocket of the first track assembly to drive a track when disposed in the tracked configuration, and wherein the dual-mode axle is configured to rotate a wheel of the first wheel assembly when disposed in the wheeled configuration.

2. The work vehicle of claim 1, wherein the first track assembly includes an idler roller rotatable around an idler roller axis and the track extending around the idler roller and the track sprocket.

3. The work vehicle of claim 2, wherein a diameter of the idler roller and a diameter of the track sprocket are identical, and the idler roller and the track sprocket are spaced apart relative to the direction of travel to tension the track in an oval shape.

4. The work vehicle of claim 2, wherein the idler roller is disposed at a front inner end of the track and the track sprocket is disposed at a rear inner end of the track.

5. The work vehicle of claim 4, wherein when disposed in the tracked configuration, a power flow from the first final drive is transferred through the first drive sprocket, the first chain, the first driven sprocket to the dual-mode axle.

6. The work vehicle of claim 5, wherein when disposed in the wheeled configuration, further comprises a second wheel coupled to the final drive, a power flow from the final drive is split into a first portion transferred to the wheel and a second portion transferred to the second wheel.

7. The work vehicle of claim 2, wherein when disposed in the tracked configuration, the idler roller axis and the first drive sprocket axis are offset.

8. The work vehicle of claim 2, wherein the first track assembly includes a plurality of track rollers aligned with the direction of travel and engaging a lower portion of track.

9. The work vehicle of claim 1, wherein the dual-mode axle defines a first axis of rotation, the track sprocket defines a track sprocket axis for rotating therearound, the wheel defines a wheel axis for rotating therearound.

10. The work vehicle of claim 9, wherein when the work vehicle is disposed in a tracked configuration, the track sprocket axis is aligned co-axial with the first axis of rotation, and when work vehicle is disposed in a wheeled configuration, the wheel axis aligned co-axial with the first axis of rotation.

11. The work vehicle of claim 1, wherein an outer end of the dual-mode axle includes a flange, and when disposed in the tracked configuration, the track sprocket is attached to the flange.

12. The work vehicle of claim 11, wherein when disposed in the wheeled configuration, the wheel is attached to the flange.

13. The work vehicle of claim 1, wherein the dual-mode axle is a rear axle, and the first motor is positioned at a front portion of the main frame.

14. The work vehicle of claim 1, further comprising a second wheel coupled to the first final drive via a wheel coupler when disposed in the wheeled configuration.

15. The work vehicle of claim 14, further comprising a final drive housing configured to cover the first final drive and coupled to the wheel coupler as a single unit when disposed in the wheeled configuration.

16. The work vehicle of claim 14, further comprising a second final drive housing without connecting to the first track assembly when disposed in the tracked configuration.

17. The work vehicle of claim 1, further comprising:
a second ground engaging device including one of a second track assembly or a second wheel assembly and configured to move the work vehicle in the direction of travel; and
a second common drive assembly coupled to the main frame and connected to the power source for receiving torque therefrom, the second common drive assembly including:
a second motor;
a second final drive coupled to the second motor, wherein the second motor is configured to drive the second final drive;
a second drive sprocket coupled to the second final drive and rotatable around a second drive sprocket axis by an output of the second final drive;
a second driven sprocket;
a second chain connecting the second drive sprocket and the second driven sprocket, wherein the second chain is configured to rotate the second driven sprocket around a second driven sprocket axis; and
a second dual-mode axle coupled to and rotatable by the second driven sprocket, wherein the second dual-mode axle is configured to rotate a second track sprocket of the second track assembly to drive a track when disposed in the tracked configuration, and wherein the second dual-mode axle is configured to rotate a wheel of the second wheel assembly when disposed in the wheeled configuration.

18. A drivetrain for a work vehicle for switching between a tracked configuration and a wheeled configuration, the drivetrain comprising:
a final drive;
a drive sprocket coupled to the final drive and rotatable around a drive sprocket axis by an output of the final drive;
a driven sprocket;
a chain connecting the drive sprocket and the driven sprocket, wherein the chain is configured to rotate the driven sprocket around a driven sprocket axis; and
a dual-mode axle coupled to and rotatable by the driven sprocket, wherein the dual-mode axle is configured to rotate a track sprocket of a track assembly to drive a track when disposed in the tracked configuration, and wherein the dual-mode axle is configured to rotate a wheel of a wheel assembly when disposed in the wheeled configuration.
